(19) United States
(12) Patent Application Publication
(10) Pub. No.: US 2026/0225837 A1
(43) Pub. Date: Aug. 6, 2026

(54) APPARATUS FOR DETECTING A TAPE START OF A LABEL ROLL

(71) Applicant: KRONES AG, Neutraubling (DE)

(72) Inventors: Michael NEUBAUER, Grassau (DE); Martin WAGNER, Regensburg (DE); Benjamin GROSSMANN, Regensburg (DE); Viktor GETTE, Woerth an der Donau (DE)

(21) Appl. No.: 19/422,299

(22) Filed: Dec. 16, 2025

(30) Foreign Application Priority Data
Jan. 31, 2025 (DE) 102025103631.4

(51) Int. Cl. B65H 7/04; B65C 9/18; B65H 3/12

(52) U.S. Cl. CPC B65H 7/04; B65C 9/1892; B65H 3/12; B65H 2405/54; B65H 2701/192; B65H 2801/75

(57) ABSTRACT

The invention relates, inter alia, to an apparatus for detecting a tape start of a label roll. The apparatus has a receiving chamber with an access opening for receiving the tape start. The apparatus further includes a suction device which is connected to the receiving chamber for suctioning the tape start through the access opening into the receiving chamber. The apparatus further includes a sensor which is arranged to detect the tape start suctioned into the receiving chamber.

### CROSS-REFERENCE TO RELATED APPLICATIONS

This application claims priority to DE 102025103 631.4, filed January 31, 2025, the contents of which are incorporated herein by reference in their entireties for all purposes.

### TECHNICAL FIELD

The invention relates to an apparatus for detecting a tape start of a label roll. The invention further relates to an associated system and a method for operating the system.

### TECHNICAL BACKGROUND

A container treatment plant can comprise a labeling device for labeling containers. For example, the labeling device can label the containers with labels from a label roll (roll of label material).

Traditionally, the label rolls are refilled manually by an operator. The user may have to perform additional tasks, such as cutting the label tape to the correct position, applying double-sided adhesive tape to the label tape, or inserting the label tape into an automatic gluing. It is also possible to use roll magazines which can be manually loaded with several rolls.

DE 102021125133 A1 describes a mobile robot, a supply system, and a method for changing label rolls on a labeling unit for labeling containers. The mobile robot accordingly comprises a vehicle unit for changing locations of the robot and a manipulator unit with a multi-axle manipulator and an associated end effector for manipulating label rolls.

EP 3760550 A1 describes a transfer unit for feeding rolls of labeling material to a labeling module that is configured to apply labels to objects. The transfer unit includes a support element configured to support a plurality of rolls arranged vertically in at least one stack. The transfer unit further has a robot arm configured such that it removes at least one roll from the stack at a gripping station and releases it at a release station.

The invention is based on the object of creating an improved technique for supporting loading a labeling system.

### SUMMARY OF THE INVENTION

The object is achieved by the features of the independent claims. Advantageous developments are specified in the dependent claims and the description.

One aspect relates to a (e.g., stationary) apparatus for (e.g., position) detection of a tape start of a label roll (e.g., for a container treatment plant). The apparatus has a receiving chamber (e.g., suction slot or suction nozzle) with an access opening for receiving the tape start. The apparatus further has a suction device which is connected to the receiving chamber for suctioning in the tape start through the access opening into the receiving chamber. The apparatus further has a sensor which is arranged to detect the tape start suctioned into the receiving chamber.

Advantageously, the apparatus allows for automated and process-reliable detection of the tape start of label rolls with comparatively little effort. The apparatus can therefore be advantageously used as part of an automated solution for the automated loading of labeling device, thus relieving operating personnel and avoiding errors when refilling label rolls. The apparatus is advantageously suited for various label widths and materials. Depending on the sensor used, transparent labels can advantageously also be processed. Advantageously, the detection can be largely independent of environmental conditions, such as lighting conditions (which may be problematic when using a camera).

In one exemplary embodiment, at least one of the following is fulfilled:

the receiving chamber is elongated and/or slot-shaped and/or has a substantially plate-like cuboid shape;

the access opening is slot-shaped and/or elongated and/or strip-shaped;

the access opening is horizontally oriented;

the receiving chamber is vertically oriented;

the longitudinal side walls of the receiving chamber are aligned with the longitudinal edges of the access opening; and

the receiving chamber has a depth of ≥ 20 mm and/or ≤ 100 mm starting from the access opening.

Advantageously, the receiving chamber can thus allow for reliable suctioning in and detection of the tape start protruding from the label roll. Furthermore, depending on the requirements, the depth can ensure that the suctioned-in tape start is located only in the receiving chamber and does not, for example, enter an adjacent suction line. There, deformation of the tape start due to contact with the inner walls of the suction line due to the flow cannot be ruled out. Alternatively, it is possible and advantageous, for example, for the depth of the receiving chamber to deliberately bring about the effect of deforming the tape start. In this process, the tape start can be suctioned into the apparatus to such an extent that it extends into the suction line and is permanently plastically (mechanically) deformed there, which can lead to easy detection of the deformed tape start. Depending on the configuration of the device that next grips the tape end, it may be more advantageous to choose one of the two variants. The device mentioned can be, for example, a gripper or it can glue the tape end of this new label roll to the end of the previous label roll. For example, the device can be a splicing device. A deformation of the tape start would be desirable, for example, if the aforementioned device does not achieve a high suction force for suctioning the tape start, or only grips the tape start mechanically.

In another exemplary embodiment, the suction device has a suction line, preferably a vacuum line, which is connected to the receiving chamber.

In one embodiment, at least one of the following conditions is met:

the receiving chamber opens directly into the suction line, preferably along the entire length of the receiving chamber;

the receiving chamber extends tangentially or radially from a round, preferably circular, cross-section of the suction line;

the receiving chamber opens into an elongated, preferably strip-shaped, inlet opening of an elongated, preferably straight, line portion of the suction line;

the side walls of the receiving chamber and the suction line are integrally formed in one piece, and

the suction line is connected to a vacuum source (e.g., the suction device or the apparatus or the system).

Preferably, a longitudinal axis of the access opening and/or a longitudinal axis of the receiving chamber and/or a longitudinal axis of the inlet opening and/or a longitudinal axis of the elongated line portion are arranged parallel to each other and/or directly one above the other.

In a further embodiment, at least one of the following conditions is met:

the sensor is an optical sensor, preferably a light barrier, a laser sensor or an LED sensor, or an ultrasonic sensor or a mechanical switch or a capacitive sensor; and

the sensor is aligned to emit a sensor beam substantially vertically to a longitudinal axis of the receiving chamber and/or the access opening.

In one embodiment, the apparatus further comprises an elongated, preferably cylindrical or cuboid, beam path chamber for a sensor beam of the sensor, wherein the beam path chamber crosses the receiving chamber. Preferably, the sensor is arranged at one end of the elongated beam path chamber for emitting its sensor beam parallel or identical to a central longitudinal axis of the elongated beam path chamber. Preferably, a longitudinal axis of the elongated beam path chamber is arranged at an angle, preferably transversely, to a longitudinal axis of the receiving chamber and/or the access opening. For example, one end of the elongated beam path chamber opposite the sensor is closed and/or arranged at a distance from the sensor that is greater than the detection range of the sensor. The elongated beam path chamber can advantageously allow the sensor to be arranged in such a way that the intake of extraneous air at its mounting location is minimized or prevented, and free propagation of the sensor beam is permitted.

In another embodiment, the apparatus also has a sensor mount on which the sensor is held (e.g., without tools) detachably, preferably clipped in, plugged in, snapped in or screwed in. Preferably, the sensor mount is integrally formed in one piece with the side walls of the receiving chamber. Preferably, the sensor mount is arranged on the outside of the apparatus. This makes the sensor easy to mount and accessible from the outside, which is advantageous.

In one exemplary embodiment, the apparatus further comprises at least one additional sensor mount, which is preferably identical in construction to the sensor mount and/or on which at least one further sensor can be detachably held (e.g., without tools), preferably clipped in, plugged in, snapped in or screwed in. For example, the sensor mount and at least one further sensor mount are arranged side by side, preferably along a longitudinal axis of the receiving chamber and/or the access opening. Advantageously, in this way several sensors can be arranged to detect the tape start, in order to monitor, for example, the entire length of the receiving chamber, if desired.

In a further exemplary embodiment, the apparatus also has an additional sensor arranged to emit a sensor beam which runs substantially parallel to a longitudinal axis of the access opening and/or outside the receiving chamber, for detecting a thickness of the label roll. Preferably, the additional sensor is an optical sensor, e.g., a light barrier, a laser sensor or an LED sensor, or an ultrasonic sensor. It is advantageous to check whether a correct label roll has been picked up by measuring the thickness (e.g., target/actual comparison of thickness = label height).

Another aspect relates to a system. The system includes a handling robot, preferably an articulated handling robot, with a label roll gripper, preferably an inner label roll gripper, for (e.g., inner) gripping of a label roll. The system includes at least one (e.g., stationary) apparatus as disclosed herein which is arranged within the range of reach of the handling robot (e.g., for suctioning in and detecting a tape start of a label roll gripped by the label roll gripper). Optionally, the system can also include at least one labeling device for labeling containers, which has at least one label roll holder (e.g., turntable) that is preferably arranged within reach of the handling robot to receive the label roll gripped by the label roll gripper. Advantageously, the system can use the detected position of a tape start of a gripped label roll to load a label roll holder, in order to position the label roll in a defined orientation.

In one exemplary embodiment, the system further comprises a processing device which is configured:

to operate the handling robot to rotate a label roll gripped by the label roll gripper in front of (e.g., over) the access opening (e.g., with a vertical orientation of the gripped label roll), wherein preferably a central axis of the label roll is positioned directly over the access opening; and optionally

to operate the suction device for suctioning in a tape start of the rotating label roll, and optionally

to determine a position of the tape start, preferably relative to the label roll gripper, depending on a signal emission of the sensor, wherein the signal emission preferably indicates that the suctioned-in tape start of the rotating label roll has left the receiving chamber.

Advantageously, a signal emission is used for tape start detection, indicating that the sensor is no longer occupied, which happens when the tape start is pulled out of the receiving chamber. Advantageously, this technique is particularly process-reliable, as the label tape moves much less turbulently when pulled out than when suctioned in.

Preferably, the term “processing device” can refer to an electronic system (for example, configured as a driver circuit or with microprocessor(s) and data memory) which, depending on the configuration, can perform open-loop and/or closed-loop control tasks and/or processing tasks. Although the term “control” is used herein, this can also comprise or be understood as “closed-loop control” or “control with feedback” and/or “processing” as appropriate. The processing device can, for example, be a central processing device or have multiple decentralized or distributed processing units.

In a further exemplary embodiment, the processing device is further configured:

to operate the handling robot to counter-rotate the label roll gripped by the label roll gripper in front of (e.g., over) the access opening (e.g., with a vertical orientation of the gripped label roll), wherein preferably a central axis of the label roll is positioned directly over the access opening; and optionally

to operate the suction device for suctioning in the tape start of the counter-rotating label roll; and optionally

to determine a further position of the tape start, preferably relative to the label roll gripper, depending on a further signal emission of the sensor, wherein the further signal emission preferably indicates that the suctioned-in tape start of the counter-rotating label roll has left the receiving chamber; and optionally

to determine an average position value from the determined position and the determined further position.

Advantageously, in this way the position of the tape start of the label roll can be determined particularly accurately. For example, the length of the protruding tape start can be indefinite or variable. If only one position were determined, it could be somewhat inaccurate. On the other hand, determining the average position value from position values obtained with opposite directions of rotation of the label roll can advantageously indicate the exact position of the tape start on the label roll.

In one embodiment, the processing device is further configured:

to determine the thickness of the label roll gripped by the label roll gripper, depending on a signal emission from an additional sensor that emits a sensor beam that runs substantially parallel to a longitudinal axis of the access opening and outside the receiving chamber; and/or

to operate the handling robot to move the label roll gripped by the label roll gripper to the apparatus, preferably before rotation and/or such that a central axis of the label roll is positioned directly over the access opening; and/or

to operate the handling robot to transfer the label roll gripped by the label roll gripper to a label roll holder of the at least one labeling device, wherein an orientation of the label roll during transfer is adjusted depending on at least one of the determined position, the determined further position and the determined average position value of the tape start.

A further aspect relates to a container processing line (e.g., for controlling temperature, producing, cleaning, coating, testing, filling, closing, pasteurizing, decorating, labeling, printing, marking, laser marking, and/or packaging containers for liquid or pasty media, preferably beverages, liquid foods, or products from the pharmaceutical or healthcare industry). The container treatment plant may have the apparatus as disclosed herein or the system as disclosed herein. The container treatment plant can, for example, be a beverage filling plant.

For example, the containers can be configured as bottles, cans, canisters, cartons, flasks, vials, tubes, etc.

A further aspect relates to a method for operating a system as disclosed herein. The method comprises the following:

rotating a label roll gripped by the label roll gripper in front of (e.g., over) the access opening by the handling robot (e.g., with a vertical orientation of the gripped label roll), wherein preferably a central axis of the label roll is positioned directly over the access opening;

suctioning a tape start of the rotating label roll into the receiving chamber by the suction device (e.g., with plastic deformation of the tape start or without plastic deformation of the tape start); and

determining the position of the tape start, preferably relative to the label roll gripper, depending on a signal emission of the sensor, wherein the signal emission preferably indicates that the suctioned-in tape start of the rotating label roll has left the receiving chamber; and optionally

determining the thickness of the label roll gripped by the label roll gripper depending on a signal emission of an additional sensor that emits a sensor beam directed onto an end face (e.g., upper side or lower side) of the label roll gripped by the label roll gripper.

Advantageously, the method can achieve the same advantages as already described herein with reference to the apparatus.

In one exemplary embodiment, the method further comprises:

moving the label roll, gripped by the label roll gripper, to the apparatus by the handling robot before rotation, preferably such that a central axis of the label roll is positioned directly over the access opening.

In another exemplary embodiment, the method further comprises the following:

counter-rotation of the label roll gripped by the label roll gripper in front of (e.g., over) the access opening by the handling robot (e.g., with a vertical orientation of the gripped label roll), wherein preferably a central axis of the label roll is positioned directly over the access opening; and optionally

suctioning the tape start of the counter-rotating label roll into the receiving chamber by the suction device (e.g., with plastic deformation of the tape start or without plastic deformation of the tape start); and optionally

determining a further position of the tape start, preferably relative to the label roll gripper, depending on a further signal emission of the sensor, wherein the signal emission preferably indicates that the suctioned-in tape start of the counter-rotating label roll has left the receiving chamber; and optionally

determining an average position value from the determined position and the determined further position (e.g., using a processing device of the system).

In an embodiment, the method further comprises:

transferring the label roll gripped by the label roll gripper to a label roll holder of at least one labeling device, wherein an orientation of the label roll during transfer is adjusted depending on at least one of the determined position, the determined further position and the determined average position value of the tape start.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 shows a perspective view of an apparatus for detecting a tape start of a label roll in accordance with an exemplary embodiment;

FIG. 2 shows a perspective sectional view of the exemplary apparatus;

FIG. 3 shows a side view of the exemplary apparatus;

FIG. 4 shows a plan view of a system in accordance with an exemplary embodiment;

FIG. 5 shows a side view of the exemplary apparatus and of a label roll gripper with a gripped label roll; and

FIG. 6 shows a perspective view of the exemplary apparatus and the label roll gripper with the gripped label roll.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

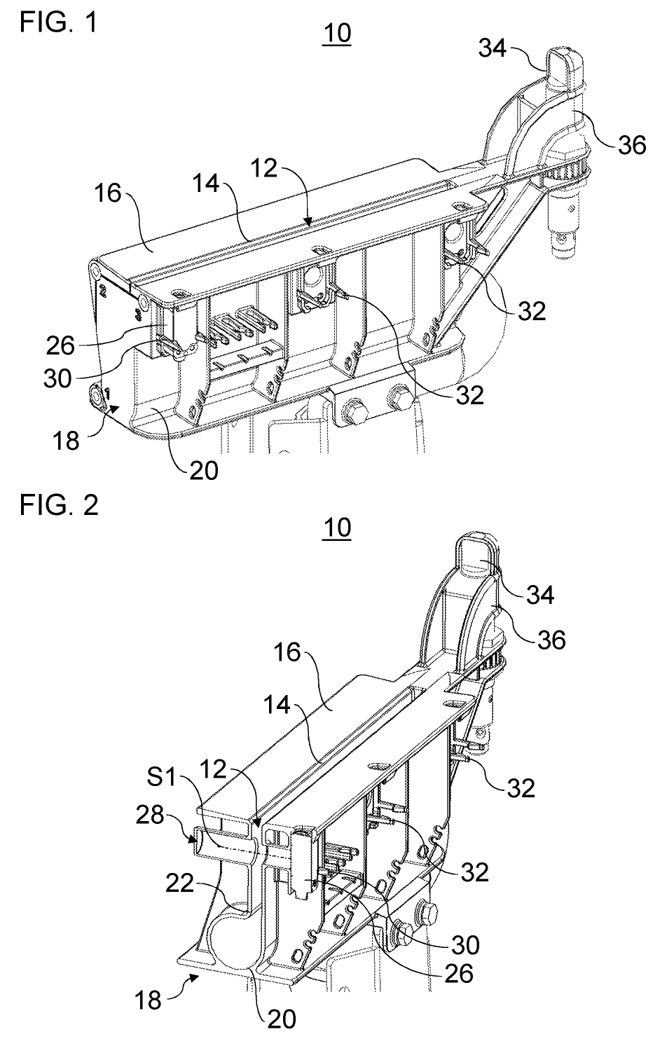

FIG. 1 to 3 show an apparatus 10 for detecting a tape start of a label roll.

The apparatus 10 has a receiving chamber 12, a suction device 18, and a sensor 26. The apparatus 10 can optionally comprise a sensor mount 30 and/or an additional sensor 34.

The receiving chamber 12 is configured to receive the tape start of the label roll. Preferably, for this purpose the receiving chamber 12 can be elongated and slot-shaped or can have a substantially plate-like cuboid shape. Preferably, a longitudinal central plane of the receiving chamber 12 can be vertically aligned.

The receiving chamber 12 has an access opening 14. The tape start can be guided from the vicinity of the apparatus 10 through the access opening 14 into the receiving chamber 12.

The access opening 14 is preferably slot-shaped, elongated or strip-shaped. Preferably, the access opening can extend in a straight line. Preferably, the longitudinal edges of the access opening 14 can be chamfered.

The access opening 14 is preferably an upper access opening. The access opening 14 can preferably be arranged on an upper side of the apparatus 10. For example, the tape start can be inserted into the receiving chamber 12 from above through the access opening 14. Preferably, the longitudinal side walls of the receiving chamber 12 can be aligned with the longitudinal edges of the access opening 14.

A planar surface 16 can preferably be arranged on one or both longitudinal sides of the access opening 14. The surface 16 can preferably be arranged in a horizontal plane. For example, the surface 16 can be rectangular.

Starting from the access opening 14, the receiving chamber 12 preferably has a depth ≥ 20 mm and/or ≤ 100 mm. The depth can preferably be measured vertical to a plane in which the access opening 14 and/or the surface 16 is located. Preferably, the receiving chamber 12 can extend downwards in a vertical direction from the access opening 14.

The suction device 18 is connected to the receiving chamber 12 to suction the tape start into the receiving chamber 12. Preferably, the receiving chamber 12 can therefore also be referred to as a suction slot or a suction nozzle.

Preferably, the suction device 18 can have a suction line 20. The suction line 20 can be connected to the receiving chamber 12. Preferably, the suction line 20 is a vacuum line.

Preferably, the suction line 20 is arranged below the receiving chamber 12. For example, the suction line 20 and the receiving chamber 12 can be adjacent to each other. The receiving chamber 12 can, for example, branch off tangentially or radially from a (e.g., circular) round cross-section of the suction line 20. Preferably, the side walls of the receiving chamber 12 and the suction line 20 can be integrally formed in one piece.

Preferably, the receiving chamber 12 opens directly into the suction line 20, preferably along the entire length of the receiving chamber 12. For example, the receiving chamber 12 can open into an elongated inlet opening 22 of an elongated line portion of the suction line 20. The inlet opening 22 is preferably strip-shaped. The line portion is preferably straight.

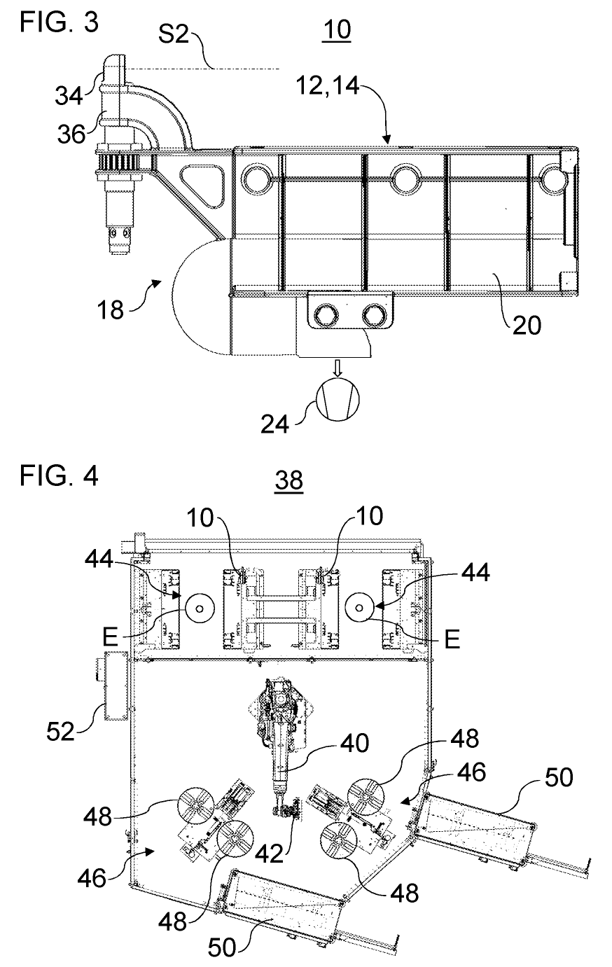

The suction line 20 can be connected to a vacuum source 24 (shown only schematically in FIG. 3). The vacuum source 24 can draw in air via the access opening 14, the receiving chamber 12 and the suction line 20. The vacuum source 24 can, for example, include a volume flow booster or a side channel blower. The vacuum source 24 can be part of the suction device 18 or at least connected to the suction device 18.

The sensor 26 is arranged to detect a tape start of a label roll suctioned into the receiving chamber 12.

Preferably, the sensor 26 is an optical sensor, e.g., a light barrier, a laser sensor or an LED sensor. Alternatively, sensor 26 can be, for example, an ultrasonic sensor, a mechanical switch, or a capacitive sensor.

Preferably, the sensor 26 is oriented such that a sensor beam S1 emitted by it crosses the receiving chamber 12 (see FIG. 2). Specifically, the sensor beam S1 can be substantially vertical to a longitudinal axis of the receiving chamber 12 and/or the access opening 14.

For example, the sensor 26 can be arranged to emit its sensor beam S1 into an elongated beam path chamber 28. The beam path chamber 28 can cross the receiving chamber 12. Preferably the beam path chamber 28 is cylindrical or cuboid in shape.

Specifically, the sensor 26 can, for example, be arranged at one end of the beam path chamber 28. The sensor 26 can emit its sensor beam S1 parallel or identical to a central longitudinal axis of the beam path chamber 28. A longitudinal axis of the beam path chamber 28 can be arranged at an angle, preferably transversely, to a longitudinal axis of the receiving chamber 12 and/or the access opening 14.

Preferably, an end of the beam path chamber 28 opposite the sensor 26 can be closed. The opposite end is preferably arranged at a distance from the sensor 26 that is greater than the detection range of the sensor. For example, the distance can be greater than 50 mm.

Preferably, the side walls of the beam path chamber 28 can be integrally formed in one piece with the side walls of the receiving chamber 12 and/or with the suction line 20.

Preferably, the sensor 26 is detachably held on the sensor mount 30. Preferably, the sensor 26 can be attached to and detached from the sensor mount 30 without tools. Preferably, the sensor 26 can be clipped, plugged, snapped or screwed into the sensor mount 30.

For example, the sensor mount 30 can have two support arms. The support arms can be positioned opposite each other. The sensor 26 can be held detachably between the support arms. The support arms can be elastically flexible for the detachable holding of the sensor 26. Preferably, the two support arms can each have a locking lug at their free ends. For example, the sensor mount 30 can substantially have a U-shape, the outer leg of which is formed by the two support arms.

Preferably, the sensor mount 30 can be arranged on the outside of the apparatus 10. Preferably, the sensor 26 can be held so as to be accessible from the outside via the sensor mount 30.

Preferably, the sensor mount 30 can be integrally formed in one piece with the side walls of the receiving chamber 12, with the side walls of the beam path chamber 28 and/or with the suction line 20.

It is possible that the apparatus 10 has at least one further sensor mount 32. At least one further sensor (not shown in the figures) can be detachably held on the at least one further sensor mount 32, for example if a further sensor is desired or required.

The at least one additional sensor mount 32 can have the same features as the sensor mount 30. Preferably, at least one additional sensor mount can be identical in construction to the sensor mount 30.

For example, the sensor mount 30 and at least one other sensor mount 32 can be arranged side by side. Preferably, the sensor mounts 30, 32 can be arranged side by side along a longitudinal axis of the receiving chamber 12 and/or the access opening 14.

The additional sensor 34 can be arranged to emit a sensor beam S2 which runs substantially parallel to a longitudinal axis of the access opening 14 and outside the receiving chamber 12. Preferably, the thickness of the label roll can be detected using the additional sensor 34.

Preferably, the additional sensor 34 can be an optical sensor, e.g., a light barrier, a laser sensor or an LED sensor, or an ultrasonic sensor.

For example, the additional sensor 34 can be arranged offset from the receiving chamber 12 and the access opening 14. For example, the additional sensor 34 can be arranged adjacent to one (e.g., longitudinal) end of the access opening 14. It is possible that a central longitudinal axis of the additional sensor 34 runs at an angle, preferably transversely, to the access opening 14.

The additional sensor 34 can, for example, be detachably held on an additional sensor mount 36. Preferably, the additional sensor 34 can be attached to and detached from the additional sensor mount 36 without tools. Preferably, the additional sensor 34 can be clipped, plugged, snapped or screwed into the additional sensor mount 30.

For example, the additional sensor mount 36 can be arranged on the outside of the apparatus 10. For example, the additional sensor mount 36 can be arranged on a longitudinal end of the apparatus 10. Preferably, the additional sensor 34 can be held so as to be accessible from the outside via the additional sensor mount 36.

For example, the additional sensor mount 36 can be configured as a protrusion of the apparatus 10. It is possible that the additional sensor mount 36, for example, protrudes from the surface 16.

It is possible that the additional sensor mount 36 is integrally formed in one piece with the side walls of the receiving chamber 12, with the side walls of the beam path chamber 28 and/or with the suction line 20.

Preferably, the apparatus 10 for detecting the tape start can be included once or multiple times in a robot cell of a supply device as disclosed in DE 102023125 933.4. DE 10 2023 125 933.4 is incorporated herein by reference with regard to the features of the supply apparatus and the features of the labeling apparatus.

FIG. 4 shows an exemplary system 38.

The system 38 is preferably part of a system for labeling containers, which can for example be comprised in a container treatment plant.

The system 38 comprises a handling robot 40 and at least one apparatus 10. Optionally, the system 38 can further comprise at least one roll storage unit 44 and/or at least one labeling device 46.

The handling robot 40 is preferably a multi-axis robot, e.g., an articulated robot. The articulated arm robot can, for example, be a 5-axis, 6-axis, or 7-axis articulated arm robot. Other robot types are also conceivable.

Preferably, the handling robot 40 is arranged in a stationary position. For example, the handling robot 40 can be arranged at a central position or in a central region within a robot cell of the system 38. However, it is also possible for the handling robot 40 to be movable, preferably along a linear axis and/or in rail-guided fashion.

The handling robot 40 can carry a label roll gripper 42 for gripping a label roll E. The label roll gripper 42 is configured to grip the label roll E with a positive grip and/or with a non-positive grip.

Preferably, the label roll gripper 42 is an inner label roll gripper with which a label roll E can be gripped by the inside of the roll core. For example, the label roll gripper can have several, preferably radially movable, inner clamping jaws with which an inner circumferential surface of a roll core of a label roll E can be clamped from the inside.

Preferably, the label roll gripper 42 can be configured like the gripping system disclosed in DE 102023125 949.0. DE 10 2023 125 949.0 is incorporated herein by reference with regard to the features of the gripping system and the features of the apparatus for handling a label roll E and the method for operating a gripping system.

The at least one roll storage unit 44 can, for example, be refilled with label rolls E manually by a user, for example by a pallet truck or forklift. Alternatively or additionally, the label rolls E can be refilled at the at least one roll storage unit 44, for example automatically by an automated guided vehicle (AGV). Preferably, the at least one roll storage unit 44 can be reached by the user, the pallet truck, the forklift, and/or the automated guided vehicle through a signal curtain or a gate of the system 38. For example, two roll storage units 44 can be comprised, as shown by way of example in FIG. 4.

The delivery of the label rolls E to the at least one roll storage unit 44 can be done for example horizontally, e.g., stacked on a pallet. The orientation of each label roll E, i.e., the position of a tape start of the label roll E on its circumference, may be unknown or undefined.

The at least one apparatus 10 is arranged within a range of reach of the handling robot 40. For example, the at least one apparatus 10 can be arranged adjacent to the at least one roll storage unit 44. Preferably, an apparatus 10 can be assigned to each roll storage unit 44. For example, two apparatuses 10 can be comprised, as shown by way of example in FIG. 4.

The at least one apparatus 10 can detect a tape start of a label roll E gripped by the label roll gripper 42. Preferably, the handling robot 40 can pick up a label roll E from a roll storage unit 44 and move it to an apparatus 10 for detecting a tape start of the picked-up label roll E.

The at least one labeling device 46 has in each case at least one label roll holder 48. The at least one labeling device 46 can for example also have a gluing device for gluing the tape end and tape start. The label roll holders 48 can each hold one label roll E. A label roll E held by a label roll holder 48 can be unwound from the relevant label roll holder 48 and fed as a label tape to a labeling unit (not shown in FIG. 4) of the corresponding labeling device 46 for labeling containers, preferably with an intermediate label tape buffer 50.

The at least one label roll holder 48 is preferably configured as a turntable. It is also possible that the label roll holders 48 are configured as, preferably vertically oriented, compartments (e.g., slide-in units) of a label roll storage device (e.g., multireel).

Preferably, at least one label roll holder 48 is arranged within the reach of the handling robot 40. The at least one label roll holder 48 can preferably receive a label roll E gripped by the label roll gripper 42.

For example, the system 38 can have two labeling devices 46, each with two label roll holders 48 and one labeling unit (not shown in FIG. 4) and optionally one label tape buffer 50 each.

The system 38 can preferably have a processing device 52. For example, the processing device 52 can operate the system 38 as explained below.

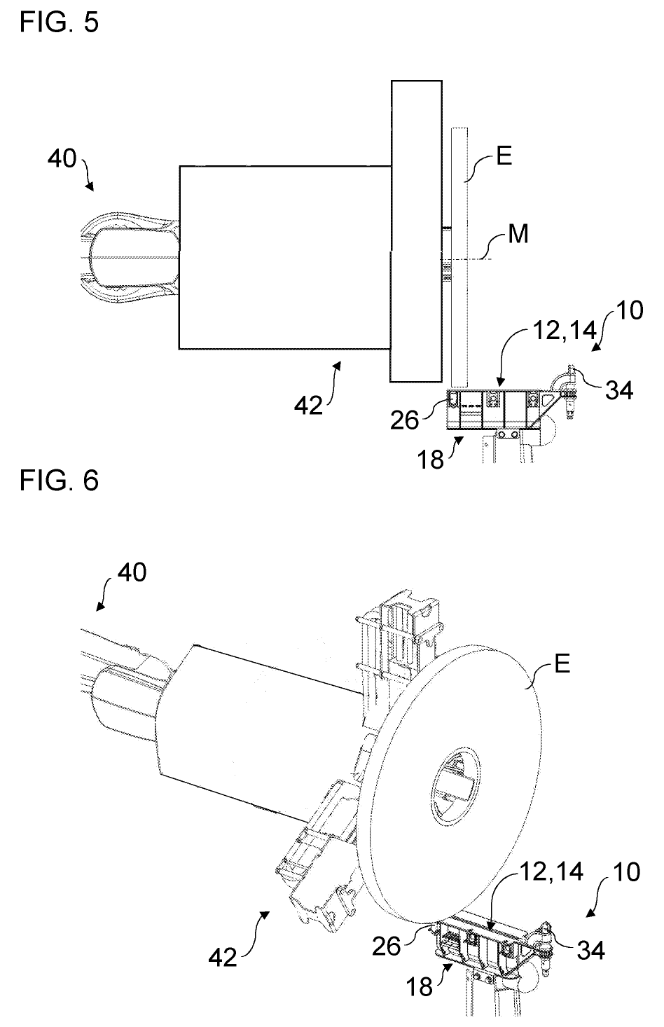

A preferred operation of the system 38 is described below, in particular with reference to FIG. 4 to 6.

A label roll E can be gripped from a roll storage unit 44 using the label roll gripper 42. The tape start of the label roll E can preferably be secured with a type of adhesive (e.g., double-sided adhesive tape). The tape start can be located anywhere on the circumference of the label roll E. The handling robot 40 can move the gripped label roll E to an apparatus 10.

Preferably, the handling robot 40 can position the gripped label roll E such that a central axis M of the label roll E is positioned directly over the access opening 14. Preferably the central axis M can be parallel to a longitudinal axis of the access opening 14. Preferably, the label roll E can be oriented vertically. An outermost layer (of the outer diameter) of the label roll E can preferably be positioned immediately adjacent to the access opening 14.

The label roll gripper 42 can rotate the gripped label roll E in front of the access opening 14 using the handling robot 40. For example, the label roll E can be rotated clockwise.

Preferably, the gripped label roll E can be rotated over the access opening 14. The rotation can be performed around the central axis M of the label roll E. Preferably, the access opening 14 can lie in a horizontal plane. This can be advantageous because it ensures that the label roll E is aligned vertically, thus preventing unwanted telescoping of the label roll E. The unwanted telescoping could otherwise occur when rotating the label roll E, which is gripped only on the inside by the label roll gripper 42, for example.

During rotation, the outer diameter of the label roll E is guided past the access opening 14. When the label roll E is rotated, at some point a tape start of the rotating label roll E can be suctioned into the receiving chamber 12 by the suction device 18, namely when the protruding tape start comes into the vicinity of the access opening 14. Depending on the length of the tape start protruding from the label roll E and the depth of the receiving chamber 12, the tape start may undergo a desired plastic deformation or no plastic deformation may occur when it is suctioned into the receiving chamber 12.

Depending on a signal emission of the sensor 26, the position of the suctioned-in tape start on the label roll E can be determined. Preferably, the signal emission indicates that the suctioned-in tape start of the label roll E, which continues to rotate, has left the receiving chamber 12 (sensor 26 is no longer occupied) after the tape start has been suctioned into the receiving chamber 12. Preferably, the position can be determined relative to the label roll gripper 42, e.g., with reference to a coordinate system and/or a rotational position of the label roll gripper 42.

Preferably, after determining the position of the tape start, the label roll E can be counter-rotated by the label roll gripper 42 in front of the access opening 14. For example, the label roll E can be rotated counterclockwise. Preferably, the central axis M of the label roll E can again be positioned directly over the access opening 14.

When the label roll E is counter-rotated, at some point a tape start of the counter-rotating label roll E can be suctioned into the receiving chamber 12 by the suction device 18. Depending on the protruding length of the tape start from the label roll E and the depth of the receiving chamber 12, a desired plastic deformation of the tape start may occur, or no plastic deformation of the tape start may occur.

Depending on a further signal emission of sensor 26, a further position of the suctioned-in tape start on the label roll E can be determined. Preferably, the further signal emission indicates that the suctioned-in tape start of the counter-rotating label roll E has left the receiving chamber 12 after the tape start has been suctioned into the receiving chamber 12. Preferably, the position can be determined relative to the label roll gripper 42, e.g., with reference to a coordinate system and/or a rotational position of the label roll gripper 42.

Preferably, for example, an average position value can then be determined from the determined position and the determined further position, e.g., by the processing device 52.

It is possible to determine the thickness of the label roll E using the apparatus 10, e.g., before, during, or after rotating the label roll E. For example, the thickness of the label roll E gripped by the label roll gripper 42 can be determined depending on a signal emission of the additional sensor 34. The additional sensor 34 or its sensor beam S2 can for example be directed towards an end face of the label roll E. For example, the signal emission can indicate a distance between the additional sensor 34 and the label roll E. For example, from the distance the processing device 52 can determine the thickness, which corresponds to a height of the labels on the label roll E.

After the tape start of the label roll E and, if applicable, the thickness of the label roll E has been detected by the apparatus 10, the handling robot 40 can move the gripped label roll E, for example to a label roll holder 48. The handling robot 40 can transfer the gripped label roll E to the label roll holder 48. Preferably, the alignment of the label roll E during transfer, and thus the alignment of the label roll E received at the label roll holder 48, can be adjusted depending on the determined position, the determined further position and/or the determined average position value of the tape start of the label roll E. The alignment can be adjusted for example by the handling robot 40 and/or the label roll gripper 42 and/or the relevant label roll holder 48. The tape start of the transferred label roll E can then be located at a defined position, which can allow for a defined further processing.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of the independent claim(s) are each disclosed independently of one another. In addition, the features of the dependent claims are also disclosed and can be claimed independently of all of the features of the independent claim(s) and, for example, independently of the features relating to the presence and/or the configuration of the receiving chamber, the suction device, and/or the sensor of the independent claim(s). All ranges specified herein are to be understood as disclosed and claimable in such a way that all values falling within the relevant range are individually disclosed, e.g., also as the relevant preferred narrower outer limits of the relevant range.

### List of Reference Signs

10 apparatus

12 receiving chamber

14 access opening

16 surface

18 suction device

20 suction line

22 entry opening

24 vacuum source

26 sensor

28 beam path chamber

30 sensor mount

32 further sensor mount

34 additional sensor

36 additional sensor mount

38 system

40 handling robot

42 label roll gripper

44 roll storage unit

46 labeling device

48 label roll holder

50 label tape buffer

52 processing device

S1 sensor beam

S2 sensor beam

E label roll

M central axis

What is claimed is:

1. An apparatus for detecting a tape start of a label roll, wherein the apparatus comprises:
a receiving chamber with an access opening for receiving the tape start;
a suction device which is connected to the receiving chamber for suctioning the tape start through the access opening into the receiving chamber; and
a sensor arranged to detect the tape start suctioned into the receiving chamber.

2. The apparatus according to claim 1, wherein at least one of the following is met:
the receiving chamber is elongated;
the receiving chamber is slot-shaped
the receiving chamber has a substantially plate-like cuboid shape;
the access opening is slot-shaped;
the access opening is elongated;
the access opening is strip-shaped;
the access opening is horizontally oriented;
the receiving chamber is vertically oriented;
longitudinal side walls of the receiving chamber are aligned with longitudinal edges of the access opening;
the receiving chamber has a depth ≥ 20 mm starting from the access opening; and
the receiving chamber has a depth ≤ 100 mm starting from the access opening.

3. The apparatus according to claim 1, wherein:
the suction device has a suction line connected to the receiving chamber.

4. The apparatus according to claim 3, wherein at least one of the following is met:
the receiving chamber opens directly into the suction line;
the receiving chamber extends tangentially or radially from a round cross-section of the suction line;
the receiving chamber opens into an elongated inlet opening of an elongated line portion of the suction line;
the side walls of the receiving chamber and the suction line are integrally formed in one piece, and
the suction line is connected to a vacuum source.

5. The apparatus according to claim 1, wherein at least one of the following is met:
the sensor is an optical sensor, an ultrasonic sensor, a mechanical switch or a capacitive sensor; and
the sensor is aligned to emit a sensor beam substantially vertically to a longitudinal axis of at least one of the receiving chamber and the access opening.

6. The apparatus according to claim 1, further comprising:
an elongated beam path chamber for a sensor beam of the sensor, wherein the beam path chamber crosses the receiving chamber.

7. The apparatus according to claim 1, further comprising:
a sensor mount to which the sensor is detachably held.

8. The apparatus according to claim 7, further comprising:
at least one further sensor mount on which at least one further sensor can be detachably held,
wherein:
the sensor mount and the at least one further sensor mount are arranged side by side.

9. The apparatus according to claim 1, further comprising:
an additional sensor arranged to emit a sensor beam which runs substantially parallel to a longitudinal axis of the access opening and outside the receiving chamber, for detecting a thickness of the label roll.

10. A system, comprising:
a handling robot comprising a label roll gripper for gripping a label roll; and
at least one apparatus according to claim 1, which is arranged within a reaching range of the handling robot; and optionally
at least one labeling device for labeling containers, which has at least one label roll holder to receive the label roll gripped by the label roll gripper.

11. The system according to claim 10, further comprising:
a processing device which is configured:
to operate the handling robot to rotate the label roll gripped by the label roll gripper in front of the access opening;
to operate the suction device for suctioning in the tape start of the rotating label roll; and
to determine a position of the tape start, depending on a signal emission from the sensor.

12. The system according to claim 11, wherein:
the processing device is further configured:
to operate the handling robot to counter-rotate the label roll gripped by the label roll gripper in front of the access opening;
to operate the suction device for suctioning in the tape start of the counter-rotating label roll;
to determine a further position of the tape start, depending on a further signal emission of the sensor; and optionally
to determine an average position value from the determined position and the determined further position.

13. The system according to claim 12, wherein:
the processing device is further configured:
to determine the thickness of the label roll gripped by the label roll gripper depending on a signal emission from an additional sensor that emits a sensor beam that runs substantially parallel to a longitudinal axis of the access opening and outside the receiving chamber; and/or
to operate the handling robot to move the label roll gripped by the label roll gripper to the apparatus, and/or such that a central axis of the label roll is positioned directly over the access opening; and/or
to operate the handling robot to transfer the label roll gripped by the label roll gripper to a label roll holder of the at least one labeling device, wherein an orientation of the label roll during transfer is adjusted depending on at least one of the determined position, the determined further position and the determined average position value of the tape start.

14. A method for operating a system according to claim 10, wherein the method comprises:
rotating a label roll gripped by the label roll gripper in front of the access opening by the handling robot;
suctioning a tape start of the rotating label roll into the receiving chamber by the suction device; and
determining the position of the tape start depending on a signal emission from the sensor; and optionally
determining a thickness of the label roll gripped by the label roll gripper depending on a signal emission of an additional sensor that emits a sensor beam directed onto an end face of the label roll gripped by the label roll gripper.

15. The method according to claim 14, wherein:
the method further comprises:
moving the label roll, gripped by the label roll gripper, to the apparatus by the handling robot before rotation; and/or
the method further comprises:
counter-rotating the label roll gripped by the label roll gripper in front of the access opening by the handling robot;
suctioning the tape start of the counter-rotating label roll into the receiving chamber by the suction device;
determining a further position of the tape start depending on a further signal emission of the sensor; and optionally
determining an average position value from the determined position and the determined further position; and/or
the method further comprises:
transferring the label roll gripped by the label roll gripper to a label roll holder of at least one labeling device, wherein the orientation of the label roll during transfer is adjusted depending on at least one of the determined position, the determined further position and the determined average position value of the tape start.

16. The apparatus according to claim 1, wherein at least one of the following is met:
the suction device has a vacuum line connected to the receiving chamber;
the sensor is an optical sensor, which is a light barrier, a laser sensor or an LED sensor;
the apparatus further comprises an elongated, cylindrical or cuboid, beam path chamber for a sensor beam of the sensor, wherein the beam path chamber crosses the receiving chamber, wherein: (a) the sensor is arranged at an end of the elongated beam path chamber for emitting its sensor beam parallel or identical to a central longitudinal axis of the elongated beam path chamber; (b) a longitudinal axis of the elongated beam path chamber is arranged at an angle, optionally transversely, to a longitudinal axis of the receiving chamber and/or the access opening; and/or (c) an end of the elongated beam path chamber opposite the sensor is closed and/or arranged at a distance from the sensor that is greater than a detection range of the sensor;
the apparatus further comprises a sensor mount to which the sensor is detachably held by being clipped in, plugged in, snapped in or screwed in, wherein: (a) the sensor mount is integrally formed in one piece with the side walls of the receiving chamber; and/or (b) the sensor mount is arranged on the outside of the apparatus;
the apparatus further comprises at least one further sensor mount, which is identical in construction to the sensor mount and/or on which at least one further sensor can be detachably held, by being clipped in, plugged in, snapped in or screwed in, wherein the sensor mount and the at least one further sensor mount are arranged side by side along a longitudinal axis of the receiving chamber and/or the access opening; and
the apparatus further comprises an additional sensor arranged to emit a sensor beam which runs substantially parallel to a longitudinal axis of the access opening and outside the receiving chamber, for detecting a thickness of the label roll, wherein the additional sensor is an optical sensor, which is a light barrier, a laser sensor or an LED sensor.

17. The apparatus according to claim 16, wherein at least one of the following is met:
the receiving chamber opens directly into the suction line along the entire length of the receiving chamber;
the receiving chamber extends tangentially or radially from a circular cross section of the suction line;
the receiving chamber opens into an elongated, strip-shaped, inlet opening of an elongated, straight, line portion of the suction line;
the side walls of the receiving chamber and the suction line are integrally formed in one piece, and
the suction line is connected to a vacuum source.

18. The system according to claim 10, wherein at least one of the following is met:
the handling robot is an articulated handling robot, with a label roll gripper, which is an inner label roll gripper, for gripping a label roll;
the least one label roll holder is arranged within a reaching range of the handling robot to receive the label roll gripped by the label roll gripper; and
the system further comprises a processing device which is configured:
to operate the handling robot to rotate a label roll gripped by the label roll gripper in front of the access opening, wherein a central axis of the label roll is positioned directly over the access opening;
to operate the suction device for suctioning in a tape start of the rotating label roll; and
to determine a position of the tape start, relative to the label roll gripper, depending on a signal emission from the sensor, wherein the signal emission indicates that the suctioned-in tape start of the rotating label roll has left the receiving chamber.

19. The system according to claim 18, wherein:
the processing device is further configured to:
(a) operate the handling robot to move the label roll gripped by the label roll gripper to the apparatus, before rotation and/or such that a central axis of the label roll is positioned directly over the access opening; and/or
(b)(1) operate the handling robot to counter-rotate the label roll gripped by the label roll gripper in front of the access opening, wherein a central axis of the label roll is positioned directly over the access opening;
(b)(2) operate the suction device for suctioning in the tape start of the counter-rotating label roll;
(b)(3) determine a further position of the tape start, relative to the label roll gripper, depending on a further signal emission of the sensor, wherein the further signal emission indicates that the suctioned-in tape start of the counter-rotating label roll has left the receiving chamber; and
(b)(4) determine an average position value from the determined position and the determined further position.

20. The method according to claim 14, wherein at least one of the following is met:
a central axis of the label roll is positioned directly over the access opening;
the position of the tape start is determined relative to the label roll gripper, depending on a signal emission from the sensor, wherein the signal emission indicates that the suctioned-in tape start of the rotating label roll has left the receiving chamber; and
the thickness of the label roll gripped by the label roll gripper is determined depending on the signal emission of the additional sensor that emits the sensor beam directed onto the end face of the label roll gripped by the label roll gripper.
